(19) United States
(12) Patent Application Publication
(10) Pub. No.: US 2009/0259954 A1
(43) Pub. Date: Oct. 15, 2009

(54) METHOD, SYSTEM AND COMPUTER PROGRAM PRODUCT FOR VISUALIZING DATA

(75) Inventors: Vijil E. Chenthamarakshan, Palakkad (IN); Anshu N. Jain, Bangalore (IN); Raghuram Krishnapuram, Bangalore (IN); Krishna Kummamuru, Bangalore (IN); Debapriyo Majumdar, Bangalore (IN)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/103,457

(22) Filed: Apr. 15, 2008

(51) Int. Cl. G06F 3/048

(52) U.S. Cl. 715/764

(57) ABSTRACT

A plurality of data attributes are displayed to a user. The user makes a selection of at least two of the attributes. An initial one of the selected attributes is displayed, together with all possible values for the initial one of the selected attributes. The user selects at least one of the possible values for the initial one of the selected attributes. A second one of the selected attributes is displayed, together with all possible values for the second one of the selected attributes that correspond to the selected value of the preceding attribute, along with a corresponding measure for each of the possible values for the second one of the selected attributes

### FIELD OF THE INVENTION

The present invention relates to the electrical, electronic and computer arts, and, more particularly, to computer-aided data visualization and the like

### BACKGROUND OF THE INVENTION

Data visualization plays a significant role in data-driven decisions (for example, decisions within an enterprise). Both the importance and the impact of data-driven decisions have been emphasized by enterprise consultants and similar individuals. The objective(s) of a person who is using a data visualization tool may vary, for example, from obtaining answers to a specific set of questions, to discovering new observations based on the data. If a data visualization tool is appropriately designed, it can be used to interactively explore the data, based on intermediate observations. Such a tool can be used not only for answering specific questions, but also for discovering new, and often surprising, observations

OLAP (on-line analytical processing) is a popular methodology for analyzing data. In particular, with current OLAP techniques, where it is desired to employ analysis of unstructured data for enterprise decisions, generally, a structured data model is extracted from the unstructured data, and use is made of traditional OLAP models to analyze the structured data (which represents the information in the unstructured data). Current OLAP techniques thus provide visualization tools to analyze the data, and are effective on transactional (structured data) data models. However, current OLAP visualization tools cannot take care of those data dimensions that have textual content.

### SUMMARY OF THE INVENTION

Principles of the present invention provide techniques for visualizing data. In one aspect, an exemplary method (which can be computer implemented) for such visualization includes the steps of displaying to a user a plurality of attributes of the data; obtaining from the user a selection of at least two of the attributes; displaying an initial one of the selected attributes, together with all possible values for the initial one of the selected attributes; and obtaining from the user a selection of at least one of the possible values for the initial one of the selected attributes. A further step includes displaying a second one of the selected attributes, together with all possible values for the second one of the selected attributes that correspond to the selection of the at least one of the possible values for the initial one of the selected attributes, along with a corresponding measure for each of the possible values for the second one of the selected attributes.

One or more embodiments of the invention or elements thereof can be implemented in the form of a computer product including a computer usable medium with computer usable program code for per forming the method steps indicated. Furthermore, one or more embodiments of the invention or elements thereof can be implemented in the form of a system/apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

These and other features, aspects and advantages of the present invention will become apparent from the following detailed description of illustrative embodiments thereof, which is to be read in connection with the accompanying drawings.

### BRIEF DESCRIPTION OF THE DRAWINGS

FIGS. 1-3 show successive screens in an exemplary analysis tool, according to an aspect of the invention;

FIG. 4 shows exemplary attribute selection, according to another aspect of the invention;

FIG. 5 shows an exemplary screen at analysis start-up, according to a further aspect of the invention;

FIGS. 6-8 show additional screens in the exemplary tool;

FIG. 9 shows an exemplary range selection screen, according to an additional aspect of the invention;

FIG. 10 depicts a computer system that may be useful in implementing one or more aspects and/or elements of the present invention;

FIG. 11 shows a data tree structure, according to a still further aspect of the invention;

FIG. 12 shows a mouse-hovering technique, according to an even further aspect of the invention;

FIG. 13 shows numerical and time series ranging, according to yet a further aspect of the invention;

FIG. 14 shows an exemplary screen, according to still another aspect of the invention; and

FIG. 15 shows a flow chart of exemplary method steps, according to yet another aspect of the invention.

### DETAILED DESCRIPTION OF PREFERRED EMBODIMENTS

Most data visualization techniques assume numerical data. Those techniques that process non-numerical data typically display the data in a geometric space, after appropriately transforming the data. One or more embodiments of the invention address data containing attributes with categorical and/or numerical, as well as textual, values. Techniques are disclosed for visualizing co-occurrences of various attribute values in an interactive way. Furthermore, one or more embodiments provide a visualization tool to analyze data also containing textual fields; the exemplary tool has (1) an intuitive user-interface, (2) ease of interactivity, and (3) the capability to easily generate required reports.

One or more embodiments of the invention provide a visualization tool for OLAP-type analysis. Traditionally, OLAP has been used for analysis of structured data. Of late, it has been extended to unstructured data, as known from Burdick et al., “OLAP over uncertain and imprecise data,” VLDB J. 16(1): 123-144 (2007).

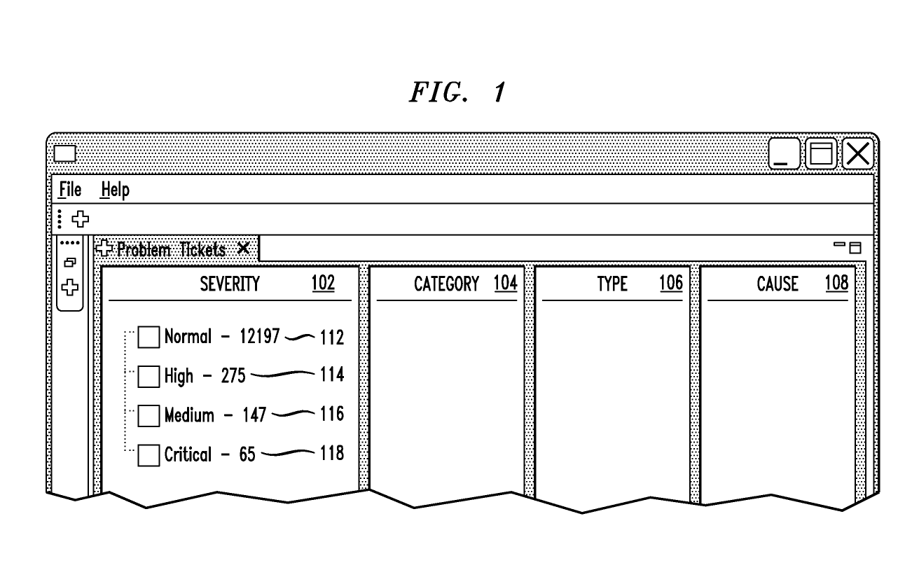

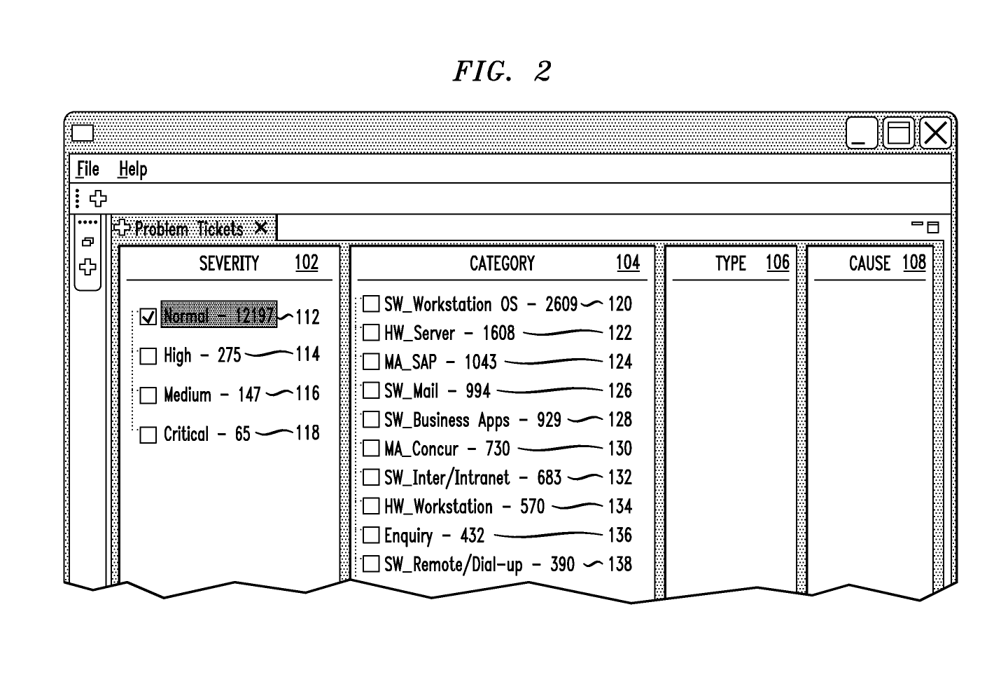

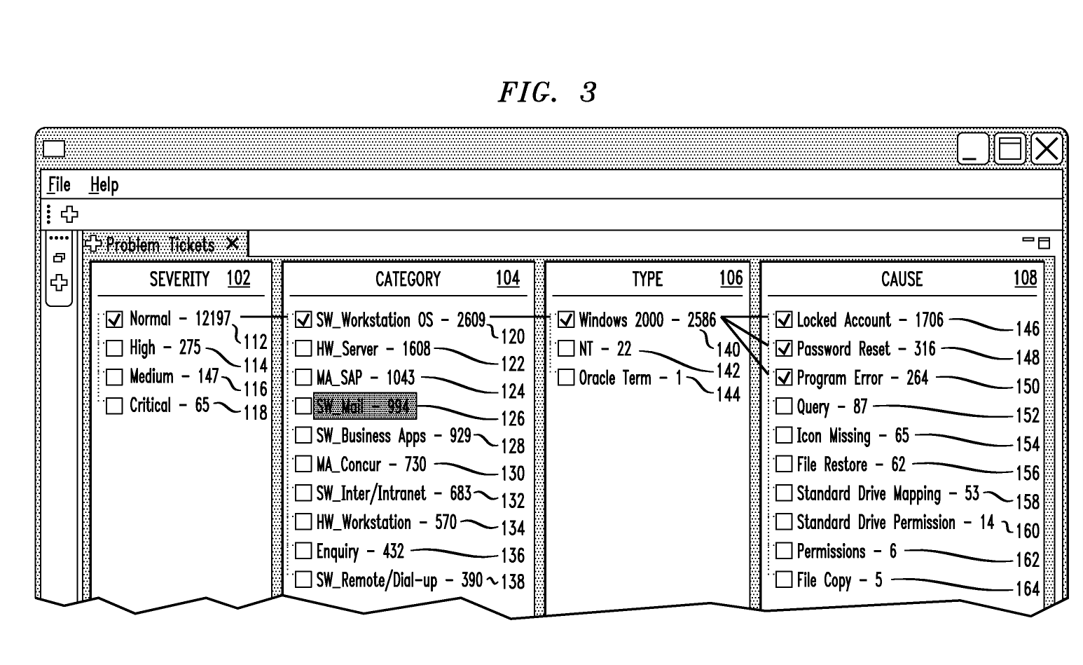

For purposes of illustrating an exemplary embodiment of the invention, analysis of structured data will first be described. With reference to FIGS. 1-3, the user interface includes of a set of columns, 102, 104, 106, 108. Each column corresponds to an attribute of the data. Each attribute column includes various values of the attribute, as best seen in FIGS. 2 and 3. To start with, as seen in FIG. 1, the first column to the left, column 102, lists all possible values for the corresponding attribute (in this case, the attribute is “severity”) and the rest of the columns, 104, 106, 108, are blank. The order in which the attributes (e.g., severity, category, type, and cause) are listed in the columns could be based, for example, on the measure chosen to analyze the data or on any other suitable criterion (for example, alphabetical order and the like). One non-limiting example of a measure chosen to analyze data is as follows—consider transactions data generated at various outlets of a retail chain—the measures could be the sales across various states, profits per product category, and so on.

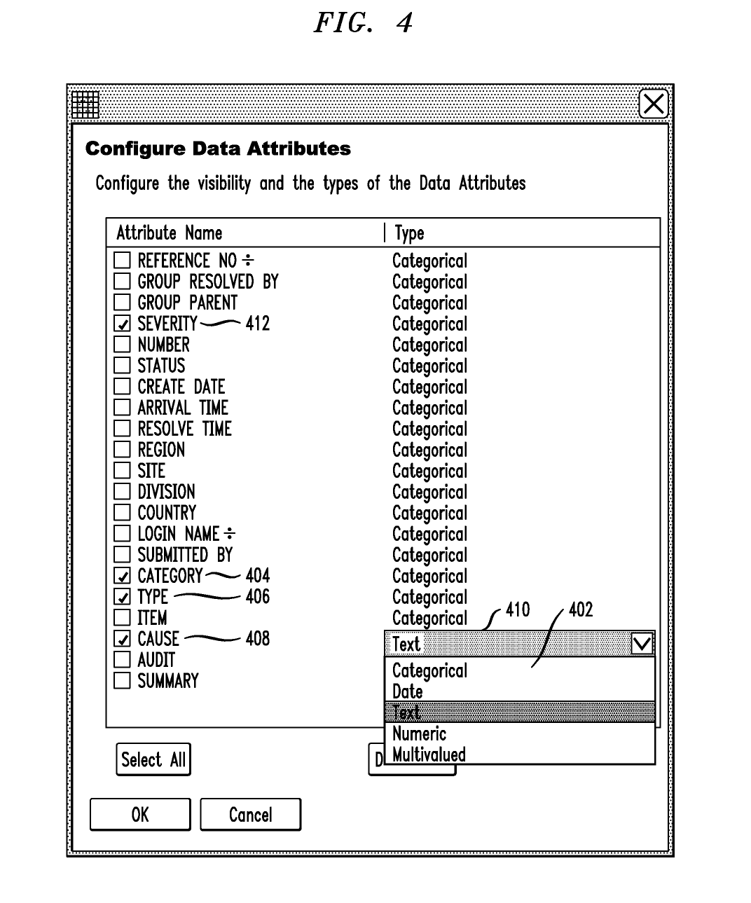

The user is given the choice to select one or more attributes for display (as will be discussed below with regard to FIG. 4), and within a given attribute, can select a desired one (or more) of the values of the attribute. For example, in FIG. 1, the attribute “severity” in the first column 102 has four values, namely, normal, high, medium, and critical, numbered 112, 114, 116, 118. With reference to FIG. 2, once a value of the first attribute is chosen (in this case, the “normal” value of the attribute “severity”), the values (typically, only those with non-zero resultant measure) of the attribute corresponding to the next adjacent column (in this case, the values of the attribute “category” in column 104) appear in the next adjacent column in a pre-defined order. The order could be based, for example, on the OLAP measure, value of the attribute, relevance rank resulting from search, and so on. The resultant measure of the values is obtained as a result of drill-down of the data with respect to the chosen value of the attribute in the previous column. That is, once “normal” is chosen in column 102, values of “category” that correspond to normal severity are determined by drill-down in the data and are displayed in column 104. The values of “category” in FIG. 2 are numbered as 120 through 138, using even number's. Thus, the user is enabled to interactively drill-down into the data.

A non-limiting example will now be presented in the context of analysis of problem ticket data. Such data typically includes problems or bugs reported to the help desk of an organization Various attributes of the data are severity, category, type, and cause, as briefly discussed above and numbered 102, 104, 106, 108. FIGS. 1-3 present screen shots of an exemplary tool implementing certain inventive techniques, at various intermediate steps of the analysis. To start with, as mentioned above, the tool shows all

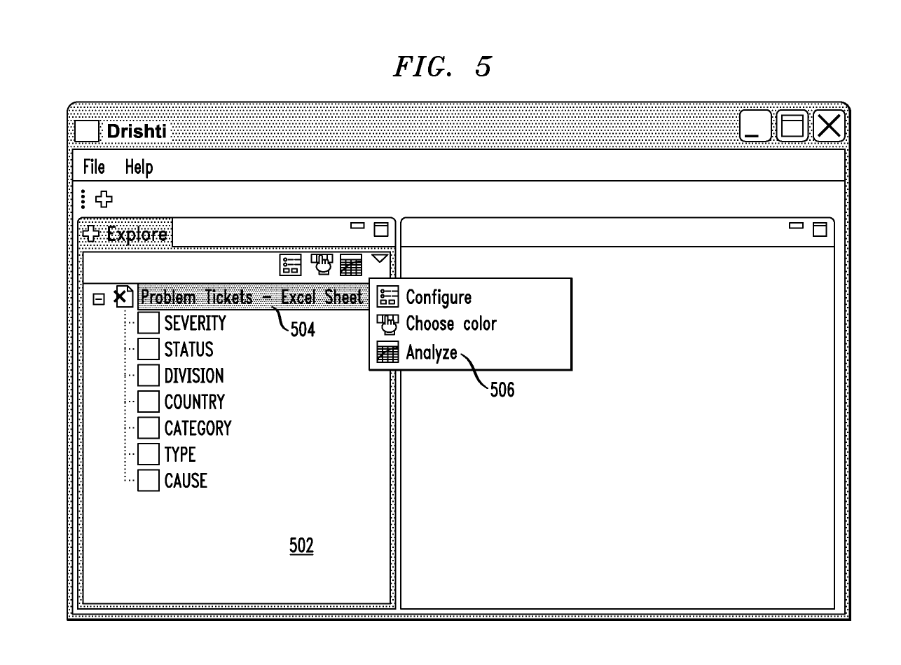

Following selection of attributes, the spreadsheet can be imported. The time required for this step may vary, for example, from essentially 0 seconds, up to 10-15 seconds for files as large as 20 MB. After this step, the (spreadsheet) file is visible in the exemplary tool. With reference back to FIG. 5, after selecting the “Excel sheet” node 504, the user can click on the “analyze” action 506. This will open up the analysis view, as shown, for example, in FIGS. 1-3. In one or more embodiments, the user can show or hide the columns during the analysis using a “context” menu.

A non-limiting example of an application of one or more embodiments of visualization tool, according aspects of the invention, includes the analysis of problem ticket data (for example, so-called “bugs”) of an organization. The various attributes of the data are:

### Severity/Status/Create Date/Arrival Time/Resolve Time/Region/Site/Division/Country/Login/Name/Submitted By/Category/Type/Cause/Audit/Summary

One or more embodiments of a tool, according to aspects of the invention, allows picking all or few of the attributes which it is desired to use for the analysis. In this example, consider analyzing to determine the root cause of the problems. Thus, some relevant attributes can be picked. One or mote embodiments of the tool allow dynamically adding additional dimensions to the analysis without having to initialize the whole system again.

As discussed above, examples of attributes that can be selected include “severity” “categoiy,” “system,” and “cause”. The order of attributes can be chosen, by which it is desired to “narrow” the analysis. The attributes can be added to or removed from the analysis dynamically. The order can also be dynamically changed, without having to initialize the system. The existing analysis is preferably preserved as far as semantically possible in all the above cases. The first three attributes just mentioned are categorical items, and can have a reasonably finite number of possible values. The last attribute, “cause” is a user entered unstructured text string, and can be expected to have as many distinct values as the number of records. However, one or more embodiments of the tool, while preprocessing the data, analyze the values under this attribute, and by picking out values of the attribute “severity” in column 102. Upon clicking on the value “normal,” at 112, for the attribute “severity,” the second column 104 is populated with various problem categories along with the measure (count, in this case) for the corresponding values.

For example, in this case, there is a count of 2609 workstation operating system software problems, as shown at 120, and a count of 1608 server hardware problems, as shown at 122. Similarly, when the attribute values in a column are checked, the values in the subsequent columns appear with the appropriate measure and in decreasing values of the measure (category 120, shown at the top, has 2609 occurrences, while the last category 138 has only 390 occurrences). Of course, the values could be displayed from low to high, or in some other order, as well FIG. 3 shows columns 106 (“type”) and 108 (“cause”) filled in as well. The value of “category” corresponding to problems with workstation operating system software was selected, as seen at 120 in FIG. 3, and this resulted in the values of “type” displayed in column 106. The values of “type” are Windows® 2000 140, Windows NT® 142, and Oracle Term 144 (WINDOWS and WINDOWS NI are registered marks of Microsoft Corp, Redmond, Wash. for operating systems; ORACLE is a registered mark of Oracle International Corporation, Redwood City Calif. 94065, for computer software) “Windows 2000” was selected as shown at 140, resulting in the display of the indicated values of “cause” displayed in column 108. The different values of “cause” are numbered from 146 to 164, using even numbers.

By way of review:
In the above example, the tool, on initialization, immediately shows the occurrence of various values in the “severity” column 102, since “severity” was picked as the first attribute. FIG. 1 shows that after configuring the attributes to show, the tool, on loading, without any interaction from the user, already shows what the possible values of “severity” are; in addition, the total records have been partitioned into the four smaller subsets, namely, normal, high, medium, and critical.
Now, there is a desire to see the categories of all the “normal” problem tickets and thus the user clicks on the check box. The system immediately shows the categories of the problem tickets along with their frequencies, in column 104.
In the next two clicks (for a total of three clicks in all), the distribution of problem tickets has been identified into categories, and it is apparent that “SW_Workstation OS” and “HW_Server” are the two main issues. Further, within the “SW_Workstation_OS” issues, a locked account as been identified as one of the major causes of problems, as shown in column 108.

Reference should now be had to FIG. 4. The system, on initialization, identifies all possible attributes, and prompts the user to select the attributes which he or she wants to index for analysis of the data. At this point, the user can also select the type of the attributes (for example, categorical, text, numerical, or time-based). In FIG. 4, the user selects “severity,” at 412, “categoiy,” at 404, “type,” at 406, and “cause,” at 408. In this particular example, only the “cause” field contains textual data, as shown at 410 (the type of the attribute can be chosen using the drop down menu 402, as discussed below). In a preferred embodiment, the tool also has the capability to dynamically add one or more dimensions to the analysis without having to initialize the whole system again. Once the tool starts up, the user is presented with a collapsible configuration panel 502 on the left, which shows dimension selection, as shown in FIG. 5. Using this panel, one can order the sequence of attributes. The attributes can also be ordered by dragging the column heading and dropping at the required place. In this embodiment, the entire configuration for the analysis requires only these two steps.

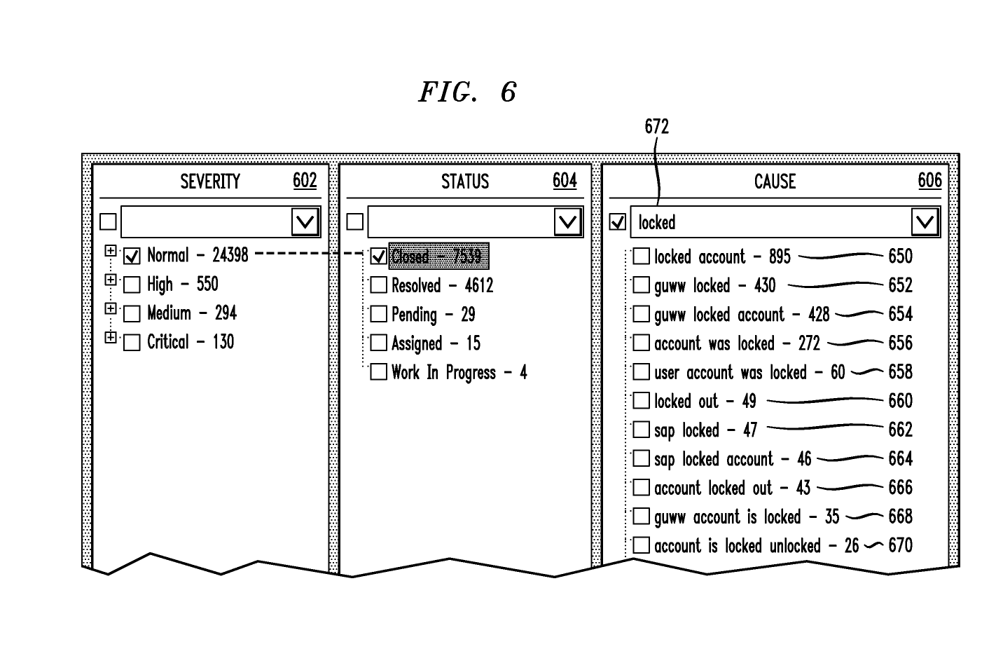

FIG. 6 shows an example with column 602, similar to column 102, followed by column 604 for “status” and column 606 for “cause.” The “cause” attribute in column 606 contains textual values. To deal with this unstructured data, in one or more embodiments, the tool, while preprocessing the data, analyzes the textual values under this attribute, and, by picking out the keywords and phrases, lists them as possible values for this attribute. That is, for the attribute “Cause” the tool, during preprocessing uses natural language understanding (NLU) or similar techniques to pick out keywords and phrases from the unstructured data; the resulting keywords and phrases are “locked account,” “guww locked,” and so on, as numbered using even numbers from 650 through 670.

Numerical attributes can also be segmented into predefined or automatically determined interval values, and those interval values can be shown in the column corresponding to the attribute. Similarly, temporal attributes, such as time and/or dates, can be categorized into weeks, months, and/or years and can be shown as values for the attribute.

As described above and shown in FIGS. 1 to 3, it is possible to drill down with respect to any value of a dimension. The values displayed in a column can be sorted based on: OLAP measure, attribute value, one or more search criteria, and so on FIGS. 1-3 show sorting by OLAP measure. FIG. 6 shows the list of values containing the “locked” key word (seen at 672) in the column 606 titled “Cause” Similar search facilities can be extended to other types of attributes as well.

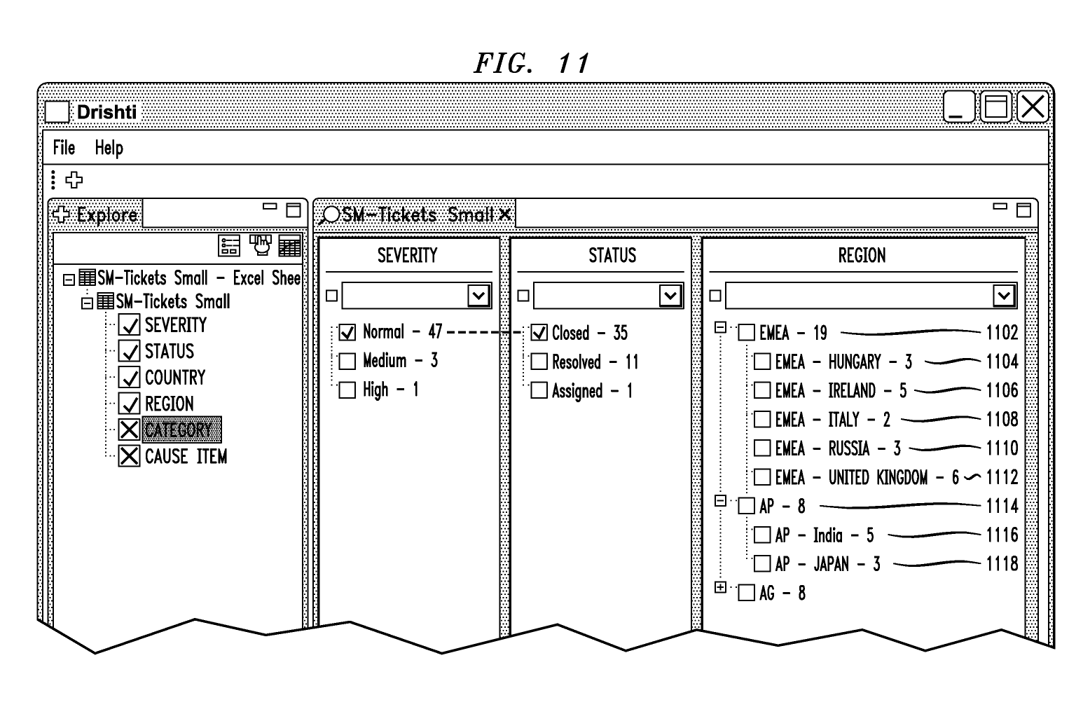

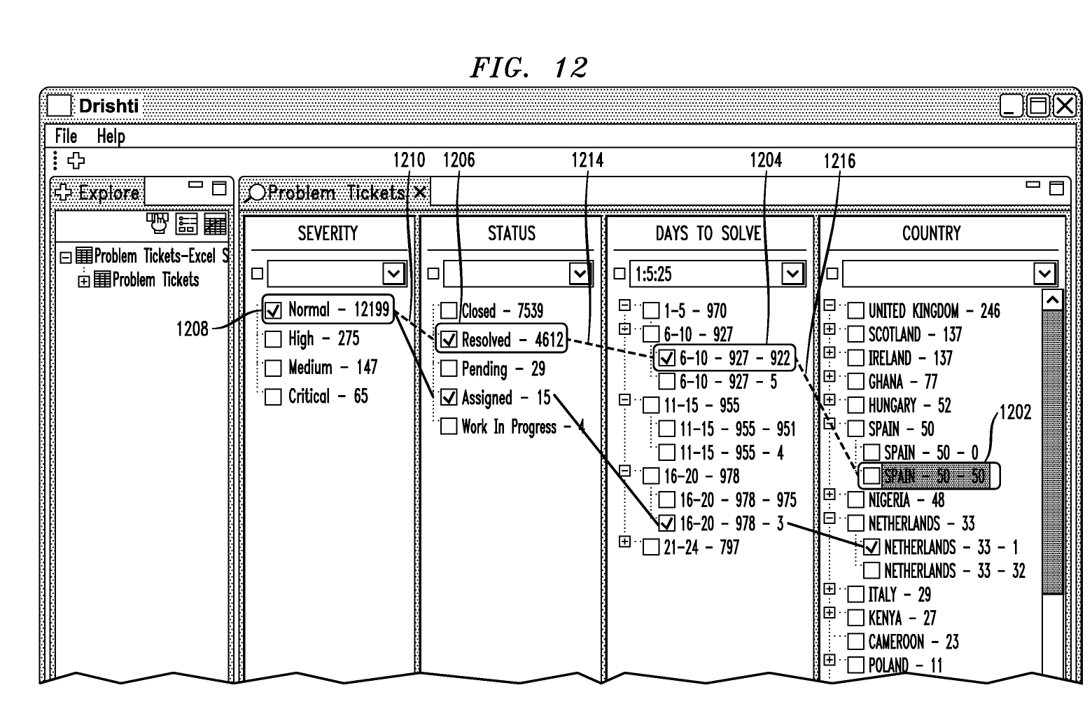

Some attributes ate hierarchical in nature. For example, the location attribute could be a city name, which belongs to a state, country, region and continent. The drill down and roll-ups of this data, with respect to hierarchical-valued attributes, can be performed using a tree display within the column corresponding to the attribute. Fox example, with reference to FIG. 11, note the “region” column including “EMEA” entry 1102 with subentries 1104, 1106, 1108, 1110, 1112, as well as the “AP” entry 1114 with subentries 1116, 1118.

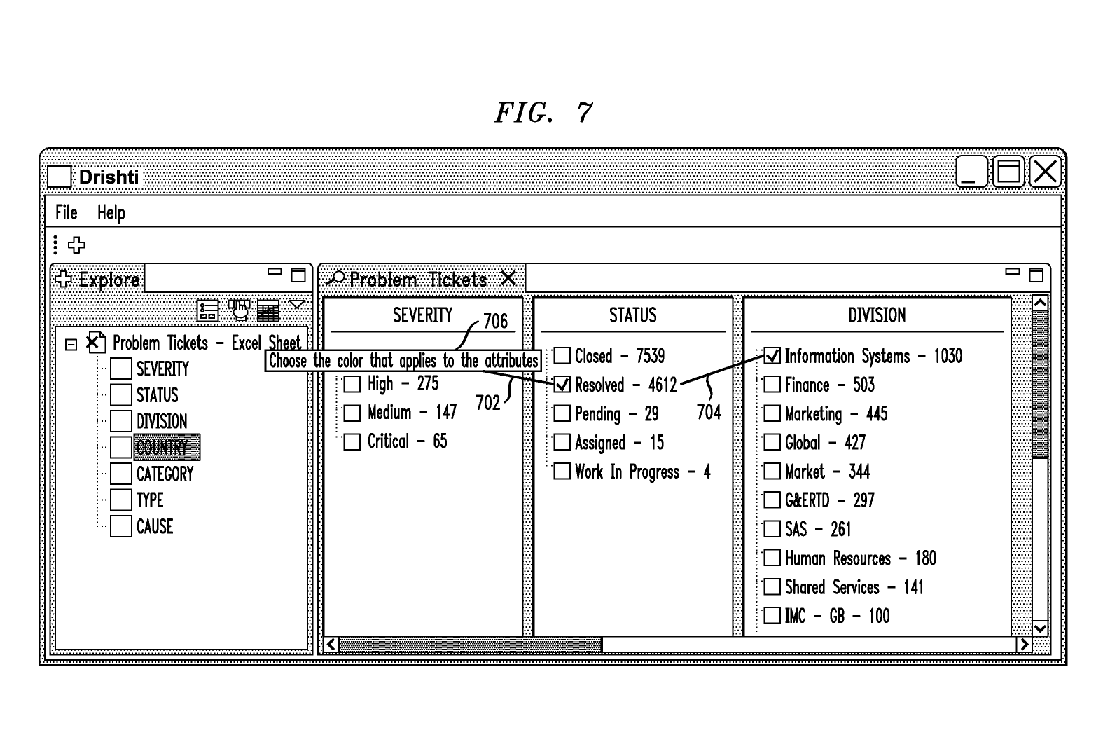

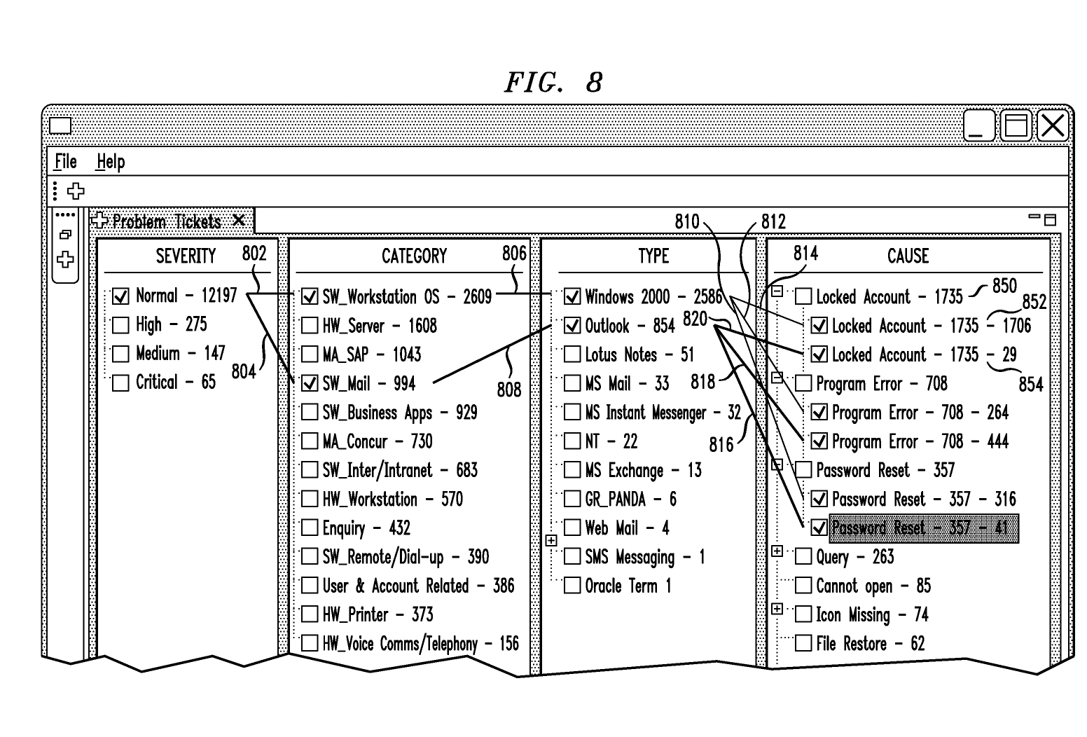

With reference now to FIGS. 7 and 8, lines, such as those designated 702, 704, and those designated by even numbers 802-820, can be displayed between the values of the different attributes. These lines show the selected values of the attributes which co-occur to give a non-zero measure. The color of the lines that are displayed while checking the boxes in the exemplary user interface (UI) can be changed using a feature of the UI, as shown at 706 in FIG. 7. Once the color of the lines is changed, another set of attribute values can be displayed for comparison with the previous analysis. For example, lines 802, 806, 810, 812, 814 could be black and could show data associated with normal—SW_Workstation OS—Windows 2000—locked account, program, error, and password reset; while lines 804, 808, 816, 818, 820 could be red and could show data associated with normal—SW_Mail—Outlook®—locked account, program, error, and password reset (OUTLOOK is a registered mark of Microsoft Corp., Redmond, Wash. for electronic mail software).

For ease of visualization, a selection of color's can be provided, which can help demarcate the analysis. In this non-limiting example, the “locked account” is one case where the same cause is associated two different categories of problems. Thus, the “locked account” value breaks out into a tree, as shown at 850, 852, 854, with the resultant counts being maintained (that is, the total “locked account” count is 1735, as shown at 850, with a count of 1706 associated with the black tree, as at 852, and 29 with the red tree, as at 854).

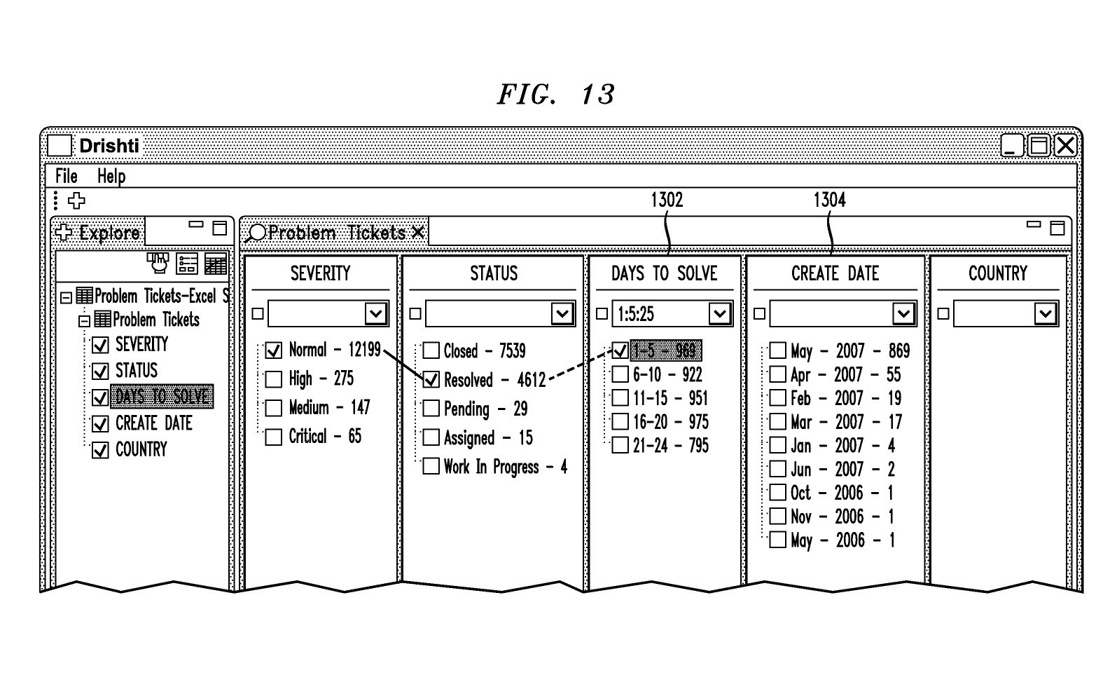

Although the tool advantageously provides for color coding, there is a potential for cluttering of connectors (lines) on the screen, when the user wants to analyze multiple intersections of attributes at the same time. Thus, a preferred embodiment of the tool provides for highlighting of the intersections while hovering (that is, keeping the mouse positioned) on them. For example, in FIG. 12, on hovering over “SPAIN-50-50,” at reference number 1202, the tool highlights the attribute values 1204, 1206, 1208 connected with dashed lines 1210, 1214, 1216.

By way of review and provision of further detail, one or more embodiments of the invention provide a method to visualize multi-dimensional data. The method includes dividing a two-dimensional display area into a two-dimensional grid, and displaying, along one of the dimensions of the grid, the various dimensions (for example, the attributes in columns 102, 104, 106, 108, 110) of the data; and in the other dimension of the grid, the relevant values of the dimensions (attributes) of the data (for example, even numbers 112-118; 120-138; 140-144; and 146-164). The method further includes, starting with the first dimension of the data, the user selecting the value of the dimension, to see the relevant values of the dimension in the subsequent row or column (column is depicted in the examples) of the grid, and displaying the measures associated with the analysis (for example, next to the attribute values and/or on the arrows) Provision can also be made for textual dimensions and/or search, as well as showing a subset of values by sorting and searching. Yet further, in one or more embodiments, provision can be made for simultaneous visualization of more than one drill down (as discussed with regard to FIGS. 7-8).

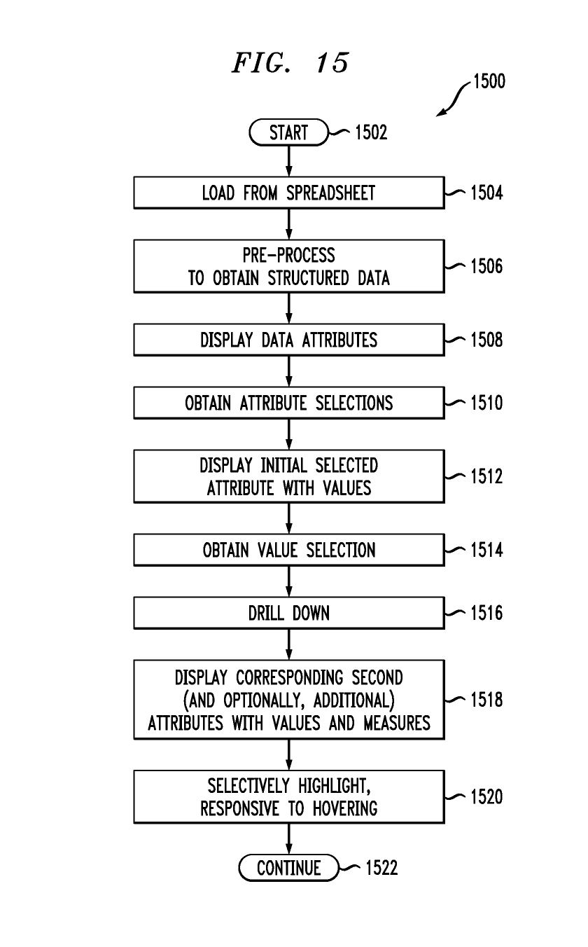

Advantageously, one or more embodiments can handle analysis of data in a variety of formats. In one preferred embodiment, the data to be analyzed can be the attribute ‘Category’ because it is in the next column (this is a result of how the attributes were ordered). If the user wanted to see all possible values of attribute ‘Type’ corresponding to Severity=Normal, using basic techniques as shown in FIGS. 1-3, he or she would have to reorder and bring attribute “Type” ahead of the attribute “Category” (which is possible in one or more embodiments of the tool, as mentioned elsewhere herein). The same holds true for the (currently last) column “Cause” the use has to reorder and bring it next to the “Severity” column to see the distribution. At such time, using the “basic” techniques, the remaining two attributes would have no information being displayed. Thus, in one or more embodiments, as depicted in FIG. 14, the need for the just-described three re-orderings, to see the distribution of the attributes in the UI with respect to the same selection, is eliminated. In this approach, in response to one “click” the tool shows the distribution of all remaining columns, with respect to a selection, which succeed the column corresponding to the selected value.

Thus, FIG. 14 illustrates that for the 47 tickets with “Severity Normal,” in column 1402, the possible values of “Region” in column 1404 are EMEA, AP and AG (27+12+8=47) and the possible values of “Country” in column 1406 are UK, Ireland, Japan, India, and so on (totaling to 47). The same is shown for column 1408, “Status.” FIG. 14 thus depicts an instance where the user selects at least three attributes (in this example, four attributes, namely, severity, region, country, and status), where the tool displays all possible values of each remaining selected attribute (that is, country and status as well as the second selected attribute, region), along with a corresponding measure, that correspond to the selection of the at least one of the possible values (in the example, “normal”) for the initial one of the selected attributes (“severity”)

Exemplary System and Article of Manufacture Details

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements contained in a spreadsheet, such as a Microsoft Excel® file (EXCEL is a registered mark of Microsoft Corp., Redmond, Wash. for spreadsheet software) Such file can be set up to contain the data which needs to be analyzed on the first sheet of the spreadsheet, and can contain on the first row the names of the columns and on the following lows the actual data. In one or more embodiments, a file selection dialog appeals, and the user selects the spreadsheet which contains the data to be analyzed. As shown in FIG. 4, a dialog appears to configure the attributes of the spreadsheet to be analyzed.

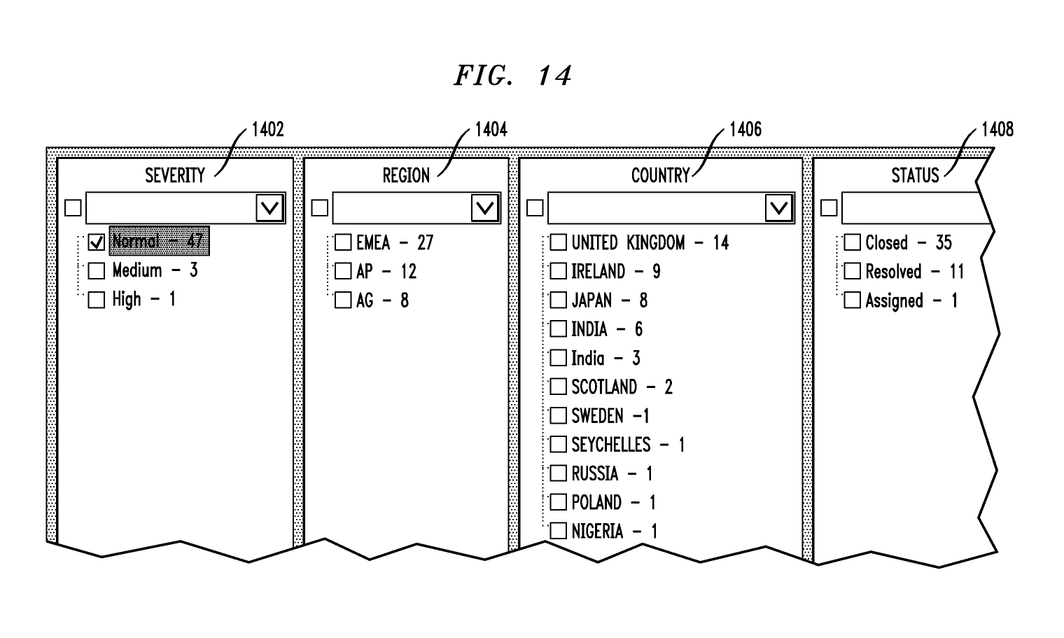

At this point, the user selects the desired attributes, as shown in FIG. 4, and then chooses the type of the attribute using the drop down menu 402. Attribute types include:
a. Categorical—an attribute which can have one of a few values—for example, “severity” can be high/low/medium, and so on, while Operating System (OS) type can be Windows/Linux®/MAC (Macintosh), and so on (LINUX is a registered mark of Linus Torvalds, 1316 SW Corbett Hill Circle, Portland Oreg. 97219, for operating system software; MacINTOSH is a registered mark of Apple Inc, Cupertino Calif. 95014, for computer software).
b. Numeric—attributes such as age and weight, which can have many values but, during analysis, it is desirable to analyze such attributes based on a range and not an exact number For example, for “age” one may want to see the number of records between 10-20, 20-30, 30-40, and so on, rather than to see the number of people at each age, that is, 10, 11, 12, 13, 14 and so on. When “numeric” is selected as the type, a popup menu asks the user to specify the range which he or she wants to use. In the example above, a range often was selected.
c. Text—This attribute permits free form text values. For example, consider “description,” which may have as many values as the number of records. Thus, it is desirable to narrow down the values to a limited set, based on keywords and natural language processing, to ease the analysis
d. Date—Allows selection of, for example, “month,” “year,” “quartei,” or “week” as the range. the keywords and phrases, classify the possible values into relatively few frequently occurring phrases. Furthermore, one or more embodiments of the tool also index the records with respect to these normalized categorical phrases. Thus, to the end user, even the unstructured data has been structured, and can be queried on the extracted keyword phrases. Similar processing can be done with numerical and time series data, and ranges of data can be used for categorization. See, for example, FIG. 13, including column 1302 with numerical ranges, and column 1304, with date ranges.

Recalling FIGS. 1-3, the system, on initialization, connects to the data source and identifies all possible attributes, and provides the user the opportunity to select the attributes he or she wants to use to analyze the data, as in FIG. 4. After this, as the user interacts with the tool, queries to the data immediately provide the user the co-occurring records depending on the selections he or she has currently made. These selections can be made, for example, simply by using checkboxes, which show the various values of the attributes.

In the above example, the tool, on initialization, immediately shows the occurrence of various values in the “seveiity” field (as seen in FIG. 1), since this has been picked as the first attribute. As discussed above, as seen in FIG. 1, after configuring the attributes that it is desired to show, the tool, on loading, without any interaction from the user, already shows what the possible values of “Severity” are, and the total records have been partitioned into the four smaller subsets (normal, high, medium, and critical).

Recalling the description of FIGS. 2-3, if a user was interested in also analyzing the cause for the category of tickets under SW_Mail, item 126, he or she could check on the adjacent box, and proceed in a similar fashion. However: since the following attribute values could be in the intersection with both the previous selection, SW_Workstation_OS issues 120, and the new selection, SW_Mail issues 126, it is desirable to clearly distinguish the two Fox this, the tool preferably makes use of the “tree within table structure,” as depicted in FIG. 8, which shows multiple intersections of the incoming values.

In view of the preceding discussion, and with reference to FIG. 15, an exemplary method 1500 for visualizing data will now be described. After beginning at step 1502, optional step 1504 includes loading data from a spreadsheet, as discussed elsewhere herein. Method 1500 includes the steps of displaying to a user a plurality of attributes of the data, as at step 1508, and obtaining from the user a selection of at least two of the attributes, as in step 1510 (see also FIG. 4). An additional step 1512, as seen also in FIG. 1, includes displaying an initial one of the selected attributes, together with all possible values for the initial one of the selected attributes. A further step 1514 includes obtaining from the user a selection of at least one of the possible values (for example, “normal” in FIG. 2) for the initial one of the selected attributes (in this example, “severity” in FIG. 2). A still further step 1518 includes displaying (at least) a second one of the selected attributes (for example, “category”), together with all possible values (in the example, elements designated by even numbers in the range 120-138) for the second one of the selected attributes, that correspond to the selection of the at least one of the possible values for the initial one of the selected attributes (in this example, the values for “category” that have a non-zero value for problems of normal severity, obtained by drilling down into the data as described above, and as indicated by step 1516). A corresponding measure for each of the possible values for the second one of the selected attributes is also displayed, for example, the measures of the values designated by even numbers in the range 120-138 are, respectively, 2609, 1608, 1043, 994, 929, 730, 683, 570, 432, and 390 Optional hovering step 1520 was discussed above with respect to FIG. 12. Processing continues at step 1522.

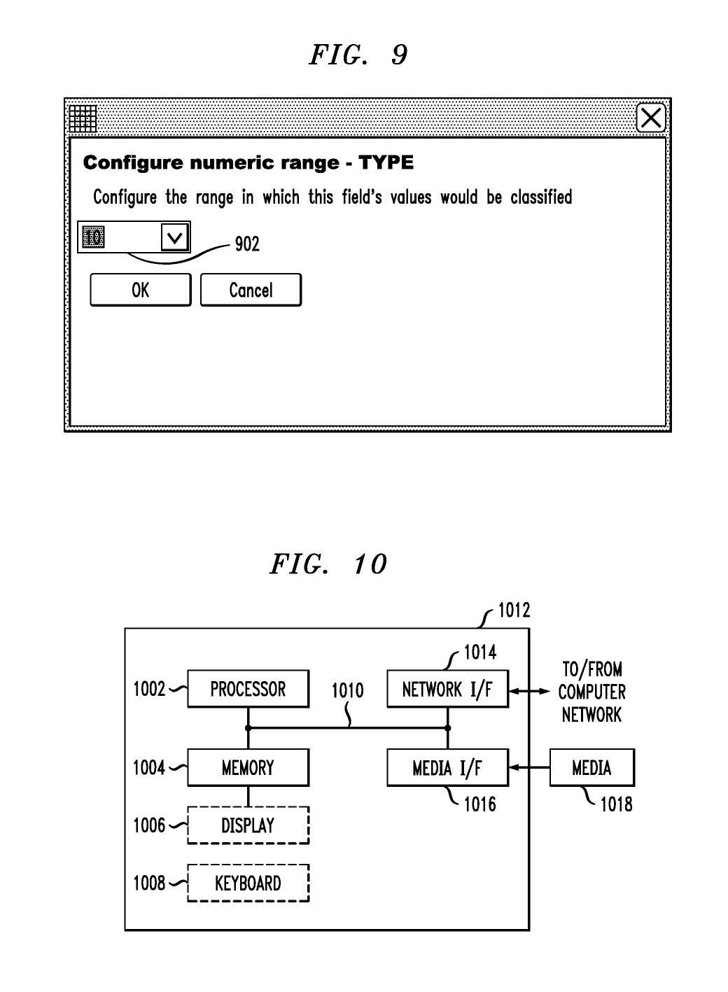

The exemplary method can be used for structured and/or unstructured data; in the latter case, an additional optional step 1506 can include preprocessing the unstructured data to classify the unstructured data into classified data. In the illustrated examples, the attributes are displayed as columns and the values comprise rows in the columns; however, the attributes could be rows and the values could be columns, ox other arrangements of data could be employed. As noted above, in one or more embodiments, numerical values of attributes can be displayed as ranges, and temporal values can be displayed as date ranges. FIG. 9 shows an example screen for selecting a desired range for display of numerical values—in this case, “10” is selected, as shown at 902, such that data would be displayed by the count in the range 0-10, the count in the range 10-20, and so on.

As best seen in FIG. 8, the user may, in some instances, select more than one possible value of a given attribute. In FIG. 8, two values have been selected under “category,” but multiple values might have been selected in the “severity” column instead, for example. In this case (multiple selections), display can include simultaneous display of all possible values for the second one of the selected attributes that correspond to the selection of the at least two of the possible values for the preceding one of the selected attributes. That is, as seen in FIG. 8, since there were two selections under “category,” subsequent columns display all the values of those attributes (the attributes in the example are “type” and “cause”) that correspond to “SW_Workstation OS” and SW_Mail.” As also noted above, in some instances, the display includes portraying links between values associated with adjacent attributes (the lines 702, 704, and those designated by even numbers from 802 through 820). The links can be displayed in different styles (for example, different colors, line weights, types of line, such as solid and dotted, and so on) corresponding to each of the selected possible values for the attribute (for example, the above-discussed red and black lines in FIG. 8).

Recall from FIGS. 1-3 that, in some instances, of the selected attributes which appear on the analysis window as columns, when the user selects a value in some attribute (column), say X, all the possible values for the immediately next attribute/column (X+1), corresponding to the value selected in column X, are shown. For example, starting with FIG. 1 after the user selects the value “Normal,” he or she sees all possible values of the second column, “Category,” as shown in the next figure, FIG. 2. Then, as the user proceeds with selecting on the third column, he or she sees the values in the third column which correspond to the selections in the first and second columns, and so on. This means that, in the exemplary instances described, any selection shows the distribution of the immediately next column (ignoring all the columns after that)

Reference should now be had to FIG. 14, which depicts exemplary techniques that extend the techniques just described. In particular, an additional behavior of the UI is provided, where instead of just showing the distribution with respect to the selected values in the succeeding column (singular), the tool shows the distribution with respect to the selected value in all the succeeding columns (plural) Reviewing FIG. 2, when the user selects Severity=Normal in the first column, he or she can see all possible values of thereof; can be implemented in the form of an apparatus including a memory and at least one processor that is coupled to the memory and operative to perform exemplary method steps.

One or more embodiments can make use of software running on a general purpose computer or workstation. With reference to FIG. 10, such an implementation might employ, for example, a processor 1002, a memory 1004, and an input/output interface formed, for example, by a display 1006 and a keyboard 1008. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 1002, memory 1004, and input/output interface such as display 1006 and keyboard 1008 can be interconnected, for example, via bus 1010 as part of a data processing unit 10122. Suitable interconnections, for example via bus 1010, can also be provided to a network interface 1014, such as a network card, which can be provided to interface with a computer network, and to a media interface 1016, such as a diskette or CD-ROM drive, which can be provided to inter face with media 1018.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 1018) providing program code for use by or in connection with a computer or any instruction execution system. For the purposes of this description, a computer usable or computer readable medium can be any apparatus for use by or in connection with the instruction execution system, apparatus, or device. The medium can store program code to execute one or more method steps set forth herein.

The medium can be an electronic, magnetic, optical, electromagnetic, infrared, or semiconductor system (or apparatus or device) or a propagation medium. Examples of a computer-readable medium include a semiconductor or solid-state memory (fox example memory 1004), magnetic tape, a removable computer diskette (for example media 1018), a random access memory (RAM), a read-only memory (ROM), a rigid magnetic disk and an optical disk Current examples of optical disks include compact disk-lead only memory (CD-ROM), compact disk-read/write (CD-R/W) and DVD.

A system, preferably a data processing system, suitable for storing and/or executing program code will include at least one processor 1002 coupled directly or indirectly to memory elements 1004 through a system bus 1010. The memory elements can include local memory employed during actual execution of the program code, bulk storage, and cache memories which provide temporary storage of at least some program code in older to reduce the number of times code must be retrieved from bulk storage during execution.

Input/output or I/O devices (including but not limited to keyboards 1008, displays 1006, pointing devices, and the like) can be coupled to the system either directly (such as via bus 1010) or through intervening I/O controllers (omitted for clarity).

Network adapters such as network interface 1014 may also be coupled to the system to enable the data processing system to become coupled to other data processing systems or remote printers or storage devices through intervening private or public networks Modems, cable modem and Ethernet cards are just a few of the currently available types of network adapters.

In any case, it should be understood that the components illustrated herein may be implemented in various firms of hardware, software, or combinations thereof; for example, application specific integrated circuit(s) (ASTCS), functional circuitry, one or more appropriately programmed general purpose digital computers with associated memory, and the like. Given the teachings of the invention provided herein, one of ordinary skill in the related art will be able to contemplate other implementations of the components of the invention.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method fox visualizing data, said method comprising the steps of:
displaying to a user a plurality of attributes of said data;
obtaining from said user a selection of at least two of said attributes;
displaying an initial one of said selected attributes, together with all possible values fox said initial one of said selected attributes;
obtaining from said user a selection of at least one of said possible values for said initial one of said selected attributes; and
displaying a second one of said selected attributes, together with all possible values for said second one of said selected attributes that correspond to said selection of said at least one of said possible values for said initial one of said selected attributes, along with a corresponding measure fox each of said possible values for said second one of said selected attributes.

2. The method of claim 1, wherein at least some of said data is structured.

3. The method of claim 1, wherein at least some of said data is unstructured, further comprising preprocessing said unstructured data to classify said unstructured data into classified data.

4. The method of claim 1, wherein said attributes are displayed as columns and said values comprise rows in said columns.

5. The method of claim 1, wherein said possible values for said second one of said selected attributes that correspond to said selection of said at least one of said possible values for said initial one of said selected attributes are based on a drill-down operation in said data.

6. The method of claim 1, wherein at least some of said values for said attributes are numerical and wherein said numerical values are displayed as ranges.

7. The method of claim 1, wherein at least some of said values for said attributes are temporal and wherein said temporal values are displayed as date ranges.

8. The method of claim 1, wherein:
in said obtaining from said user said selection of at least one of said possible values for said initial one of said selected attributes, said user selects at least two of said possible values; and
said displaying said second one of said selected attributes comprises simultaneously displaying all possible values for said second one of said selected attributes that correspond to said selection of said at least two of said possible values for said initial one of said selected attributes.

9. The method of claim 8, wherein said displaying comprises portraying links between values associated with adjacent attributes.

10. The method of claim 9, wherein said links are displayed in different styles corresponding to each of said at least two selected possible values for said initial one of said selected attributes.

11. The method of claim 9, further comprising the additional step of selectively highlighting said values associated with said adjacent attributes between which said links are portrayed, upon hovering upon a given one of said values with a pointing device.

12. The method of claim 1, wherein said user selects at least three of said attributes, further comprising displaying all possible values of each remaining selected attribute, along with a corresponding measure, that correspond to said selection of said at least one of said possible values for said initial one of said selected attributes.

13. The method of claim 1, wherein said second one of said selected attributes is hierarchical, and wherein said displaying said second one of said selected attributes comprises displaying as a hierarchical tree display.

14. The method of claim 1, further comprising the additional step of loading said data into a visualization tool, from a spreadsheet, wherein said three displaying steps and said two obtaining steps axe facilitated by said visualization tool.

15. A system for visualizing data, said system comprising:
means for displaying to a user a plurality of attributes of said data;
means for obtaining from said user a selection of at least two of said attributes;
means for displaying an initial one of said selected attributes, together with all possible values for said initial one of said selected attributes;
means for obtaining from said user a selection of at least one of said possible values for said initial one of said selected attributes; and
means for displaying a second one of said selected attributes, together with all possible values for said second one of said selected attributes that correspond to said selection of said at least one of said possible values for said initial one of said selected attributes, along with a corresponding measure for each of said possible values for said second one of said selected attributes.

16. The system of claim 15, wherein:
said means for obtaining from said user said selection of at least one of said possible values for said initial one of said selected attributes comprise means for having said user select at least two of said possible values; and
said means for displaying said second one of said selected attributes comprise means for simultaneously displaying all possible values fox said second one of said selected attributes that correspond to said selection of said at least two of said possible values for said initial one of said selected attributes.

17. A computer program product comprising a computer useable medium including computer usable program code for visualizing data, said computer program product including:
computer usable program code for displaying to a user a plurality of attributes of said data;
computer usable program code for obtaining from said user a selection of at least two of said attributes;
computer usable program code for displaying an initial one of said selected attributes, together with all possible values for said initial one of said selected attributes;
computer usable program code for obtaining from said user a selection of at least one of said possible values for said initial one of said selected attributes; and
computer usable program code for displaying a second one of said selected attributes, together with all possible values for said second one of said selected attributes that correspond to said selection of said at least one of said possible values for said initial one of said selected attributes, along with a corresponding measure for each of said possible values for said second one of said selected attributes.

18. The computer program product of claim 17, wherein:
said computer usable program code for obtaining from said user said selection of at least one of said possible values for said initial one of said selected attributes comprises computer usable program code for said user to select at least two of said possible values; and
said computer usable program code for displaying said second one of said selected attributes comprises computer usable program code for simultaneously displaying all possible values for said second one of said selected attributes that correspond to said selection of said at least two of said possible values for said initial one of said selected attributes.

19. A system for visualizing data, said system comprising:
a memory; and
at least one processor, coupled to said memory, and operative to
display to a user a plurality of attributes of said data;
obtain from said user a selection of at least two of said attributes;
display an initial one of said selected attributes, together with all possible values for said initial one of said selected attributes;
obtain from said user a selection of at least one of said possible values for said initial one of said selected attributes; and
display a second one of said selected attributes, together with all possible values for said second one of said selected attributes that correspond to said selection of said at least one of said possible values for said initial one of said selected attributes, along with a corresponding measure for each of said possible values for said second one of said selected attributes.

20. The system of claim 19, wherein said processor is further operative to:
obtain from said user said selection of at least one of said possible values for said initial one of said selected attributes by having said user select at least two of said possible values; and
display said second one of said selected attributes by simultaneously displaying all possible values fox said second one of said selected attributes that correspond to said selection of said at least two of said possible values fox said initial one of said selected attributes.
